(19) United States
(12) Patent Application Publication
(10) Pub. No.: US 2014/0374633 A1
(43) Pub. Date: Dec. 25, 2014

(54) Microvalve Having Improved Resistance to Contamination

(71) Applicant: ZHEJIANG DUNAN HETIAN METAL CO., LTD., Zhuji (CN)

(72) Inventors: Edward Nelson Fuller, Manchester, MI (US); Parthiban Arunasalam, Austin, TX (US); Chen Yang, Austin, TX (US); Mark Luckevich, Austin, TX (US); Joe Ojeda, Austin, TX (US)

(73) Assignee: ZHEJIANG DUNAN HETIAN METAL CO., LTD., Zhuji (CN)

(21) Appl. No.: 14/313,138

(22) Filed: Jun. 24, 2014

Related U.S. Application Data
(60) Provisional application No. 61/838,529, filed on Jun. 24, 2013.

(51) Int. Cl. F16K 99/00

(52) U.S. Cl. CPC F16K 99/0044
USPC 251/129.06

(57) ABSTRACT

A microvalve includes a base plate including a surface, a recessed area provided within the surface, a first fluid port provided within the recessed area, and a first sealing structure extending about the first fluid port. The microvalve also includes a cover plate including a surface, a recessed area provided within the surface, a second fluid port provided within the recessed area, and a second sealing structure extending about the second fluid port. An intermediate plate is disposed between the base plate and the cover plate and includes a displaceable member that is movable between a closed position, wherein the displaceable member cooperates with the sealing structures to prevent fluid communication between the fluid ports, and an opened position, wherein the displaceable member does not cooperate with at least a portion of the sealing structures to prevent fluid communication between the fluid ports.

### CROSS-REFERENCE TO RELATED APPLICATIONS

This application claims the benefit of U.S. Provisional Application No. 61/838,529, filed Jun. 24, 2013, the disclosure of which is incorporated herein by reference.

### BACKGROUND OF THE INVENTION

This invention relates in general to microvalves for controlling the flow of fluid through a fluid circuit. In particular, this invention relates to an improved structure for such a microvalve that resists interference with the free movement of a displaceable member of the microvalve that might otherwise result from the presence of particulate contaminants contained in the fluid flowing therethrough.

Generally speaking, a micro-electro-mechanical system is a system that not only includes both electrical and mechanical components, but is additionally physically small, typically including features having sizes in the range of ten micrometers or smaller. The term “micro-machining” is commonly understood to relate to the production of three-dimensional structures and moving parts of such micro-electro-mechanical system devices. In the past, micro-electro-mechanical systems used modified integrated circuit (e.g., computer chip) fabrication techniques (such as chemical etching) and materials (such as silicon semiconductor material), which were micro-machined to provide these very small electrical and mechanical components. More recently, however, other micro-machining techniques and materials have become available.

As used herein, the term “micro-machined device” means a device including features having sizes in the micrometer range or smaller and, thus, is at least partially formed by micro-machining. As also used herein, the term “microvalve” means a valve including features having sizes in the micrometer range or smaller and, thus, is also at least partially formed by micro-machining. Lastly, as used herein, the term “microvalve device” means a micro-machined device that includes not only a microvalve, but further includes additional components. It should be noted that if components other than a microvalve are included in the microvalve device, these other components may be either micro-machined components or standard-sized (i.e., larger) components. Similarly, a micro-machined device may include both micro-machined components and standard-sized components.

A variety of microvalve structures are known in the art for controlling the flow of fluid through a fluid circuit. One well known microvalve structure includes a displaceable member that is supported within a closed internal cavity provided in a valve body for pivoting or other movement between a closed position and an opened position. When disposed in the closed position, the displaceable member substantially blocks a first fluid port that is otherwise in fluid communication with a second fluid port, thereby preventing fluid from flowing between the first and second fluid ports. When disposed in the opened condition, the displaceable member does not substantially block the first fluid port from fluid communication with the second fluid port, thereby permitting fluid to flow between the first and second fluid ports.

In this conventional microvalve structure, the thickness of the closed internal cavity is usually only slightly larger than the thickness of the displaceable member disposed therein. Thus, relatively small spaces are provided between the displaceable member and the adjacent portions of the microvalve that define the closed internal cavity. This is done so as to minimize the amount of undesirable leakage therethrough when the displaceable member is disposed in the closed position. However, it has been found that when this conventional microvalve structure is used to control the flow of fluid containing solid particles (such as particulate contaminants that may be contained within the fluid), such particles may become jammed between the displaceable member and the adjacent portions of the microvalve that define the closed internal cavity. The jamming of such particles can, in some instances, undesirably interfere with the free movement of the displaceable member between the closed and opened positions. Thus, it would be desirable to provide an improved structure for a microvalve that resists interference with the free movement of a displaceable member of the microvalve that might otherwise result from the presence of particulate contaminants contained in the fluid flowing therethrough.

### SUMMARY OF THE INVENTION

This invention relates to an improved structure for a microvalve that resists interference with the free movement of a displaceable member of the microvalve that might otherwise result from the presence of particulate contaminants contained in the fluid flowing therethrough. The microvalve includes a base plate including a surface, a recessed area provided within the surface, a first fluid port provided within the recessed area, and a first sealing structure extending about the first fluid port. The microvalve also includes a cover plate including a surface, a recessed area provided within the surface, a second fluid port provided within the recessed area, and a second sealing structure extending about the second fluid port. An intermediate plate has a first surface that abuts the surface of the base plate and a second surface that abuts the surface of the cover plate. The intermediate plate includes a displaceable member that is movable between a closed position, wherein the displaceable member cooperates with the first and second sealing structures to prevent fluid communication between the first and second fluid ports, and an opened position, wherein the displaceable member does not cooperate with at least a portion of at least one of the first and second sealing structures to prevent fluid communication between the first and second fluid ports.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is an exploded perspective view of a basic structure of a microvalve including a cover plate, an intermediate plate, and a base plate.

FIG. 2 is a perspective view of the basic structure of the microvalve illustrated in FIG. 1 shown assembled.

FIG. 3 is a plan view of an inner surface of a conventional cover plate for a prior art microvalve.

FIG. 4 is a plan view of a conventional intermediate plate for a prior art microvalve.

FIG. 5 is a plan view of an inner surface of a conventional base plate for a prior art microvalve.

FIG. 6 is a perspective view of a portion of the inner surface of the conventional cover plate for a prior art microvalve shown in FIG. 3.

FIG. 7 is a perspective view of a portion of the inner surface of the conventional base plate for a prior art microvalve shown in FIG. 5.

FIG. 8 is a sectional elevational view of the conventional cover plate, the intermediate plate, and the base plate illustrated in FIGS. 3 through 7 shown assembled.

FIG. 9 is a plan view of an inner surface of a cover plate for an improved microvalve in accordance with a first embodiment of this invention.

FIG. 10 is a plan view of an intermediate plate for the first embodiment of the microvalve.

FIG. 11 is a plan view of an inner surface of a base plate for the first embodiment of the microvalve.

FIG. 12 is a perspective view of a portion of the inner surface of the cover plate shown in FIG. 9.

FIG. 13 is a perspective view of a portion of the inner surface of the base plate shown in FIG. 11.

FIG. 14 is a sectional elevational view of the cover plate, the intermediate plate, and the base plate illustrated in FIGS. 9 through 13 shown assembled.

FIG. 15 is a plan view of the intermediate plate and the base plate illustrated in FIGS. 9 through 14 shown assembled with a displaceable member disposed in a first operating position.

FIG. 16 is a plan view of the intermediate plate and the base plate illustrated in FIG. 15 shown assembled with the displaceable member disposed in a second operating position.

FIG. 17 is a plan view of an inner surface of a cover plate for an improved microvalve in accordance with a second embodiment of this invention.

FIG. 18 is a plan view of an intermediate plate for the second embodiment of the microvalve.

FIG. 19 is a plan view of an inner surface of a base plate for the second embodiment of the microvalve.

FIG. 20 is a perspective view of a portion of the inner surface of the cover plate shown in FIG. 17.

FIG. 21 is a perspective view of a portion of the inner surface of the base plate shown in FIG. 19.

FIG. 22 is a sectional elevational view of the cover plate, the intermediate plate, and the base plate illustrated in FIGS. 17 through 21 shown assembled.

FIG. 23 is a plan view of the intermediate plate and the base plate illustrated in FIGS. 17 through 23 shown assembled with the displaceable member disposed in a first operating position.

FIG. 24 is a plan view of the intermediate plate and the base plate illustrated in FIG. 23 shown assembled with the displaceable member disposed in a second operating position.

### DETAILED DESCRIPTION OF THE PREFERRED EMBODIMENTS

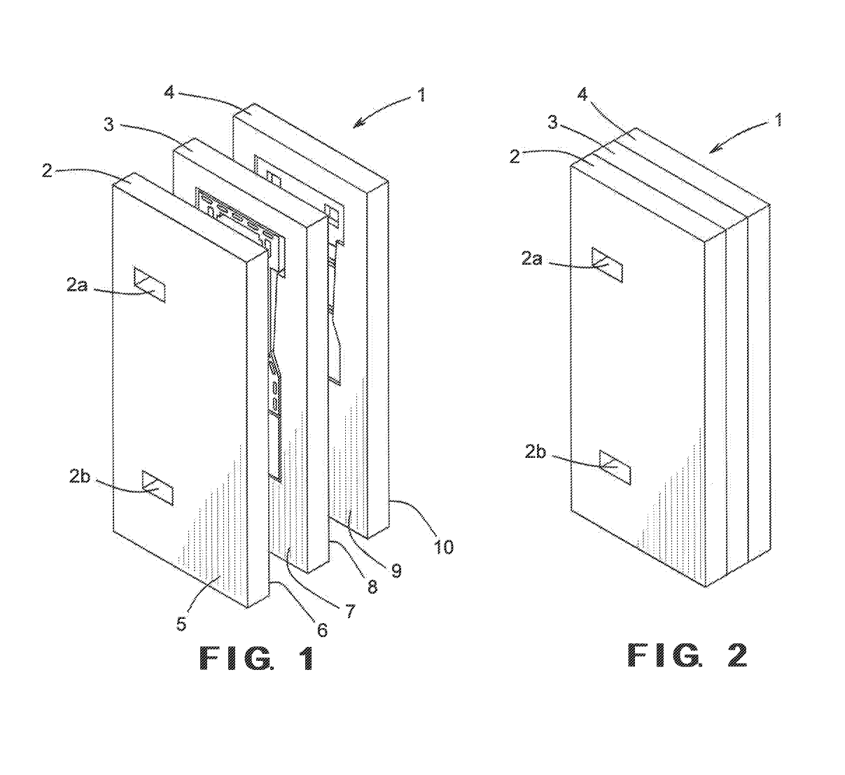

Referring now to the drawings, there is illustrated in FIGS. 1 and 2 a basic structure of a microvalve 1 that, to the extent shown, is representative of both a conventional structure for a microvalve and an improved structure for a microvalve in accordance with this invention. The illustrated microvalve 1 includes a cover plate 2, an intermediate plate 3, and a base plate 4. The cover plate 2 has an outer surface 5 and an inner surface 6. The cover plate 2 also has one or more openings (two of such openings 2a and 2b are shown in the illustrated embodiment) formed therethrough that, in a manner that is well known in the art, allow one or more electrically conductive wires (not shown) to pass therethrough. The intermediate plate 3 has a first surface 7 and a second surface 8. The base plate 4 has an inner surface 9 and an outer surface 10. The base plate 4 also has a one or more openings (three of such openings 4a, 4b, and 4c are shown in the illustrated embodiment) formed therethrough that, in a manner that is well known in the art, allow fluid to flow in to and out of the microvalve 1.

When the microvalve 1 is assembled as shown in FIG. 2, the inner surface 6 of the cover plate 2 engages the first surface 7 of the intermediate plate 3, and the inner surface 9 of the base plate 4 engages the second surface 8 of the intermediate plate 3. The cover plate 2, the intermediate plate 3, and the base plate 4 can be retained in this orientation in any desired manner. For example, portions of the cover plate 2 and/or the base plate 4 may be bonded to the intermediate plate 3, such as by fusion bonding, chemical bonding, or physically bonding (such as, for example, mechanical fasteners and/or adhesives). The cover plate 2, the intermediate plate 3, and the base plate 4 may be composed of any desired material or combination of materials. For example, the cover plate 2, the intermediate plate 3, and the base plate 4 may be composed of silicon and/or similar materials.

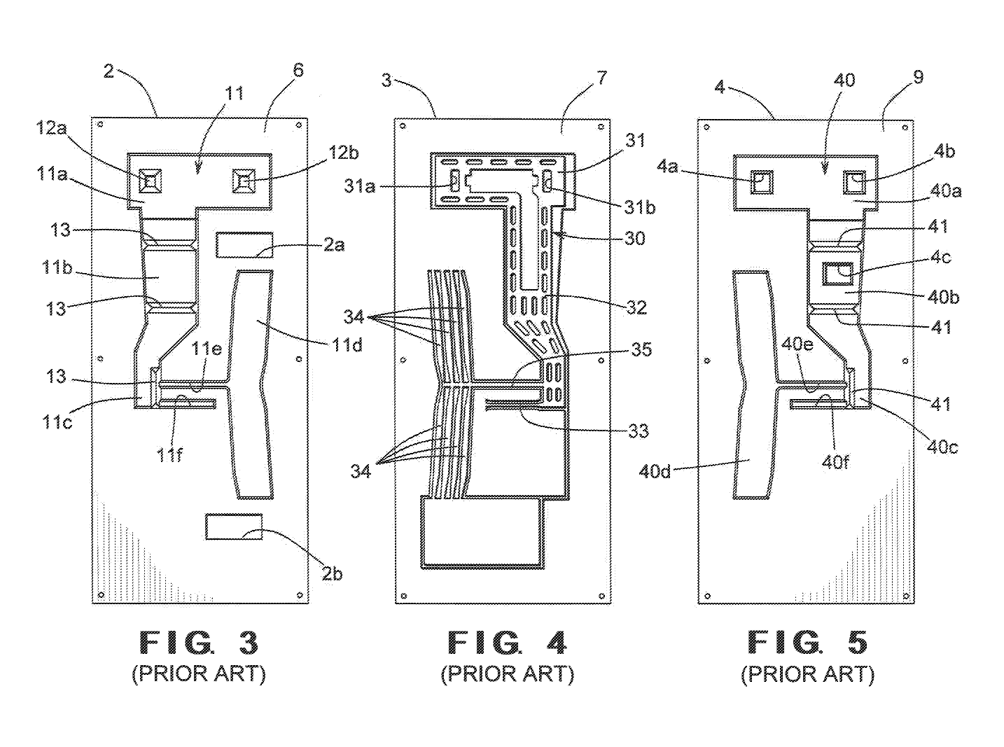

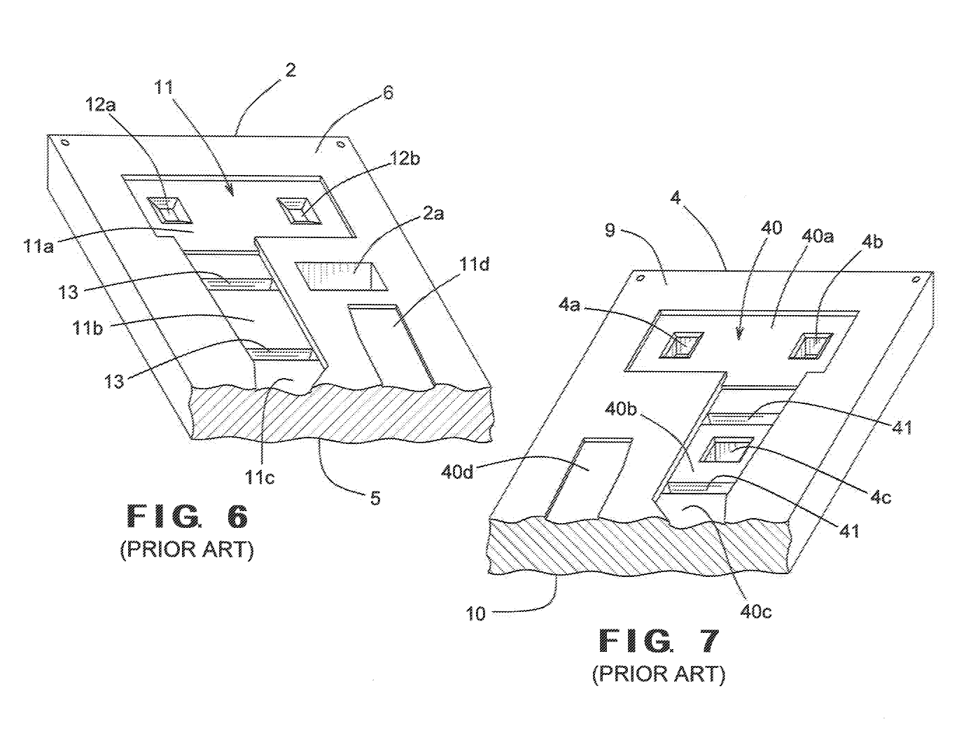

The structure of the inner surface 6 of a conventional cover plate 2 for a prior art microvalve is illustrated in detail in FIGS. 3 and 6. As shown therein, the conventional cover plate 2 includes an actuator cavity, indicated generally at 11, that is provided on the inner surface 6 thereof. The illustrated actuator cavity 11 includes an upper actuator arm cavity portion 11a, a central actuator arm cavity portion 11b, a lower actuator arm cavity portion 11c, an actuator rib cavity portion 11d, an actuator spine cavity portion 11e, and an actuator hinge cavity portion 11f. The upper actuator arm cavity portion 11a has a pair of recessed areas 12a and 12b provided therein. The illustrated actuator cavity 11 also has one or more pressure equalization depressions 13 provided therein.

The structure of a conventional intermediate plate 3 for a prior art microvalve is illustrated in detail in FIG. 4. As shown therein, the conventional intermediate plate 3 includes a displaceable member, indicated generally at 30, that includes a sealing portion 31 having a pair of openings 31a and 31b formed therethrough. The sealing portion 31 is connected through an elongated arm portion 32 to a hinge portion 33 that is formed integrally with the conventional intermediate plate 3. The intermediate plate 3 also includes an actuator including a plurality of actuator ribs 34 that is connected through a central spine 35 to the elongated arm portion 32 at a location that is intermediate of the sealing portion 31 and the hinge portion 33.

As shown in FIG. 4, first ends of a first portion of the plurality of actuator ribs 34 (the upper ribs 34 when viewing FIG. 4) are flexibly joined at first ends thereof to a first non-moving part of the intermediate plate 3. Second ends of the first portion of the plurality of actuator ribs 34 are connected to the central spine 35. The first non-moving part of the intermediate plate 3 is electrically connected to a first bond pad (not shown) that is provided on the intermediate plate 3. Similarly, first ends of a second portion of the plurality of actuator ribs 34 (the lower ribs 34 when viewing FIG. 4) are flexibly joined at first ends thereof to a second non-moving part of the intermediate plate 3. Second ends of the second portion of the plurality of actuator ribs 34 are also connected to the central spine 35. The second non-moving part of the intermediate plate 3 is electrically connected to a second bond pad (not shown) that is provided on the intermediate plate 3. The second bond pad is electrically isolated from the first bond pad, other than through the plurality of actuator ribs 34.

In a manner that is well known in the art, electrical current may be passed from the first bond pad through the plurality of actuator ribs 34 to the second bond pad. Such electrical current causes thermal expansion of the plurality of actuator ribs 34, which causes axial movement of the central spine 35. As described above, the central spine 35 is connected to the elongated arm portion 32. Consequently, axial movement of the central spine 35 causes the elongated arm portion 32 (and, therefore, the sealing portion 31) of the displaceable member 30 to pivot about the hinge portion 33 or otherwise move relative to the rest of the intermediate plate 3 (such movement occurring within a plane defined by the rest of the intermediate plate 3). Thus, the illustrated displaceable member 30 functions as a conventional micro-electro-mechanical system thermal actuator.

The structure of the inner surface 9 of a conventional base plate 4 is illustrated in detail in FIGS. 5 and 7. As shown therein, the conventional base plate 4 includes a actuator cavity, indicated generally at 40, that is provided on the inner surface 9 thereof. The illustrated actuator cavity 40 includes an upper actuator arm cavity portion 40a, a central actuator arm cavity portion 40b, a lower actuator arm cavity portion 40c, an actuator rib cavity portion 40d, an actuator spine cavity portion 40e, and a hinge cavity portion 40f. The illustrated actuator cavity 40 also has one or more pressure equalization depressions 41 provided therein.

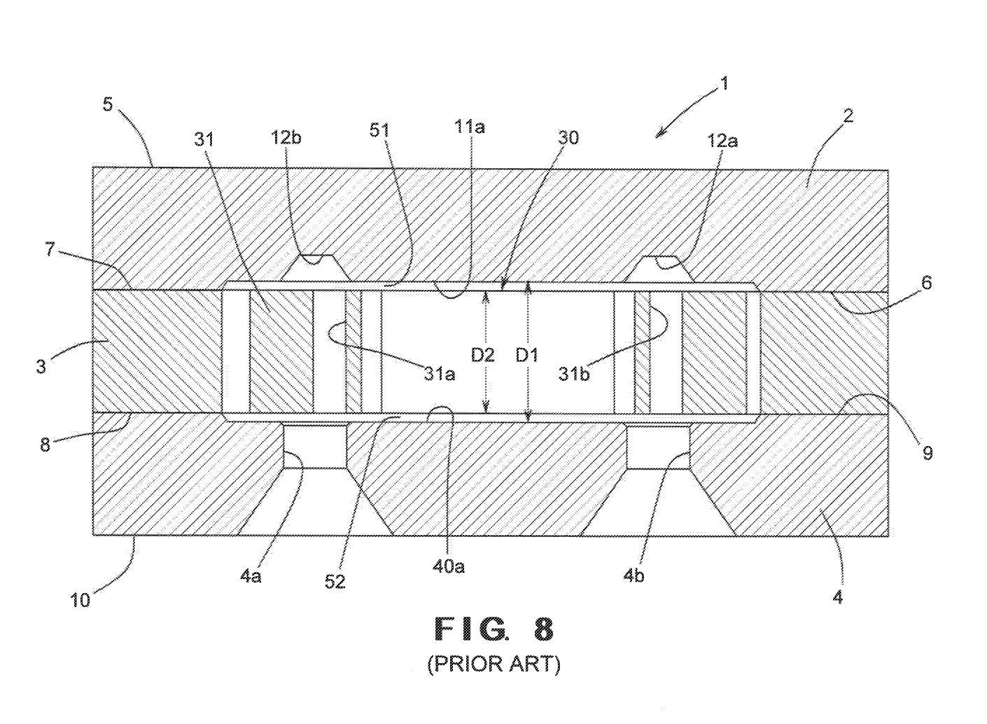

FIG. 8 illustrates the structure of the assembled conventional microvalve 1 shown in FIGS. 3 through 7. As shown therein, non-recessed portions of the inner surface 6 of the cover plate 2 engage corresponding non-recessed portions of the first surface 7 of the intermediate plate 3. Similarly, non-recessed portions of the inner surface 9 of the base plate 4 engage corresponding non-recessed portions of the second surface 8 of the intermediate plate 3. The upper actuator arm cavity portion 11a provided on the cover plate 2, the intermediate plate 3, and the upper actuator arm cavity portion 40a provided on the base plate 4 all cooperate to define a closed internal cavity in which the sealing portion 31 of the displaceable member 30 is disposed for relative pivoting movement (movement to the left and to the right when viewing FIG. 8).

A first thickness D1 for the closed internal cavity is defined between a bottom surface of the upper actuator arm cavity portion 11a provided on the cover plate 2 and a bottom surface of the upper actuator arm cavity portion 40a provided on the base plate 4 (including the sealing portion 31 of the displaceable member 30 disposed therebetween). That first thickness D1 is slightly larger than a second thickness D2 that is defined by the opposed surfaces of the sealing portion 31 of the displaceable member 30.

As a result, a first relatively small space S1 is defined between the upper actuator arm cavity portion 11a provided on the cover plate 2 and the adjacent surface (the upper surface when viewing FIG. 8) of the displaceable member 30. As shown in FIG. 8, this first relatively small space S1 extends completely throughout the upper actuator arm cavity portion 11a provided on the cover plate 2 and the adjacent (upper) surface of the sealing portion 31 of the displaceable member 30. The thickness of this first relatively small space S1 has traditionally been about 3 μm in order to prevent excessive leakage through the microvalve 1.

Similarly, a second relatively small space S2 is defined between the upper actuator arm cavity portion 40a provided on the base plate 4 and the adjacent surface (the lower surface when viewing FIG. 8) of the displaceable member 30. As also shown in FIG. 8, this second relatively small space S2 extends completely throughout the upper actuator arm cavity portion 40a provided on the base plate 4 and the adjacent (lower) surface of the sealing portion 31 of the displaceable member 30. The thickness of this second relatively small space S2 has also traditionally been about 3 μm in order to prevent excessive leakage through the microvalve 1.

In order to minimize leaking through the conventional microvalve device 1 illustrated in FIGS. 3 through 8, it is desirable that the thicknesses of the relatively small spaces S1 and S2 be as small as possible. However, because the thicknesses of these relatively small spaces S1 and S2 are not only relatively small, but are constant throughout the entire surface areas of the upper and lower surfaces of the displaceable member 30, then the likelihood increases that one or more particles (not shown) contained in the fluid leaking through such relatively small spaces S1 and S2 may become jammed therebetween. In other words, the particles may become jammed between either (1) the upper actuator arm cavity portion 11a provided on the cover plate 2 and the adjacent (upper) surface of the displaceable member 30, or (2) the upper actuator arm cavity portion 40a provided on the base plate 4 and the adjacent (lower) surface of the displaceable member 30.

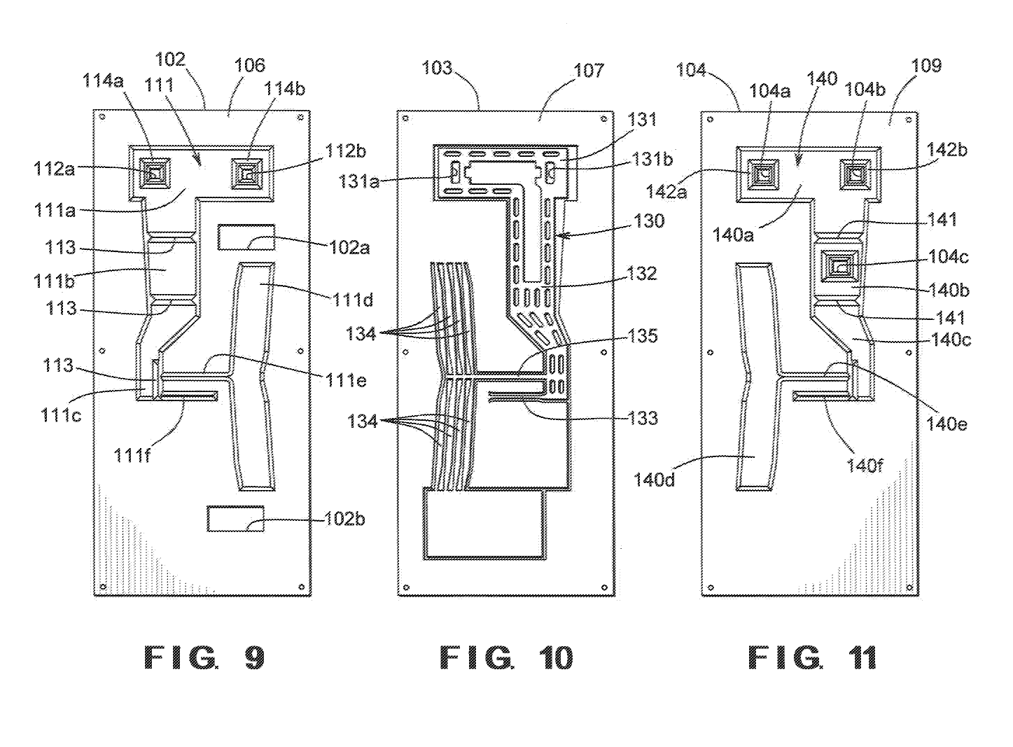

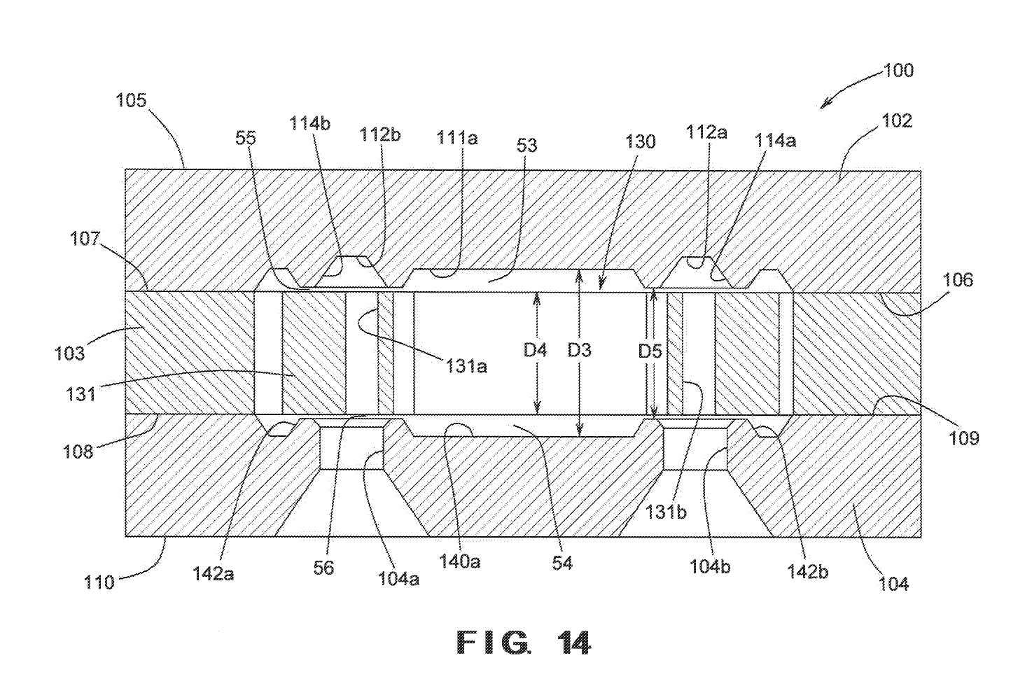

FIGS. 9 through 14 illustrate portions of an improved microvalve, indicated generally at 100 in FIG. 14, in accordance with a first embodiment of this invention that minimizes the likelihood of such undesirable jamming. As mentioned above, the basic structure of the first embodiment of the microvalve 100 is similar to that shown in FIGS. 1 and 2 and, therefore, includes a cover plate 102, an intermediate plate 103, and a base plate 104. The cover plate 102 has an outer surface 105 and an inner surface 106. The cover plate 102 also has one or more openings (two of such openings 102a and 102b are shown in the illustrated embodiment) formed therethrough that, in a manner that is well known in the art, allow one or more electrically conductive wires (not shown) to pass therethrough. The intermediate plate 103 has a first surface 107 and a second surface 108. The base plate 104 has an inner surface 109 and an outer surface 110. The base plate 104 also has a one or more openings (three of such openings 104a, 104b, and 104c are shown in the illustrated embodiment) formed therethrough that, in a manner that is well known in the art, allow fluid to flow in to and out of the microvalve 101.

When the microvalve 100 is assembled as shown in FIG. 14, the inner surface 106 of the cover plate 102 engages the first surface 107 of the intermediate plate 103, and the inner surface 109 of the base plate 104 engages the second surface 108 of the intermediate plate 103. The cover plate 102, the intermediate plate 103, and the base plate 104 can be retained in this orientation in any desired manner. For example, portions of the cover plate 102 and/or the base plate 104 may be bonded to the intermediate plate 103, such as by fusion bonding, chemical bonding, or physically bonding (such as, for example, mechanical fasteners and/or adhesives). The cover plate 102, the intermediate plate 103, and the base plate 104 may be composed of any desired material or combination of materials. For example, the cover plate 102, the intermediate plate 103, and the base plate 104 may be composed of silicon and/or similar materials.

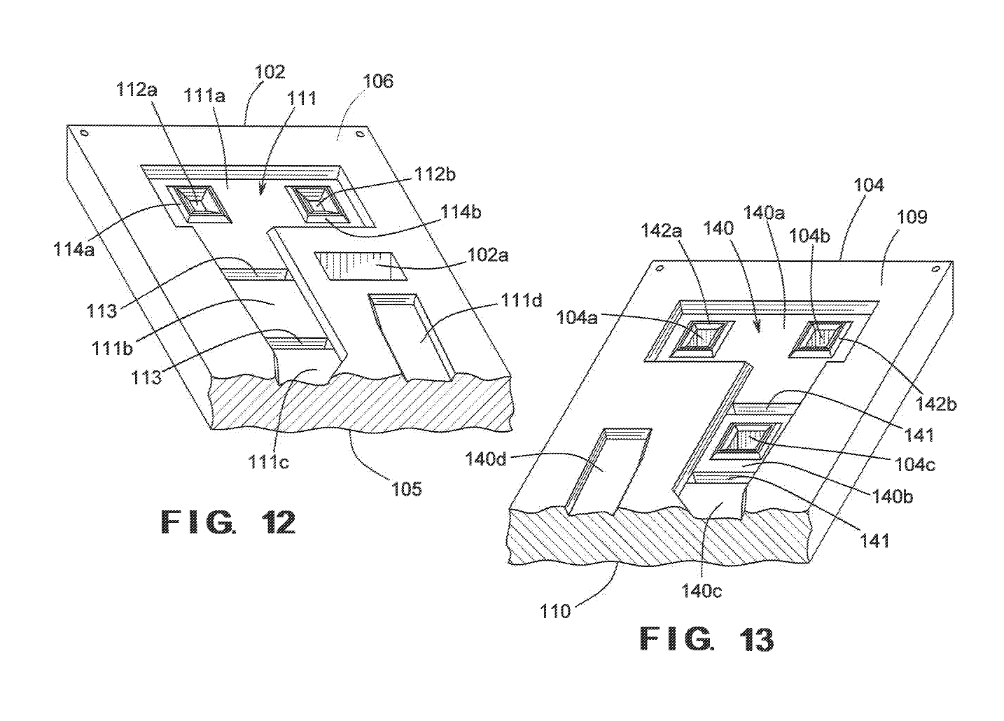

The structure of the inner surface 106 of the cover plate 102 of this invention is illustrated in detail in FIGS. 9 and 12. As shown therein, the cover plate 102 of this invention includes an actuator cavity, indicated generally at 111, that is provided on the inner surface 106 thereof. The illustrated actuator cavity 111 includes an upper actuator arm cavity portion 111a, a central actuator arm cavity portion 111b, a lower actuator arm cavity portion 111c, an actuator rib cavity portion 111d, an actuator spine cavity portion 111e, and a hinge cavity portion 111f. The upper actuator arm cavity portion 111a has a pair of recessed areas 112a and 112b provided therein. The illustrated actuator cavity 111 also has one or more pressure equalization depressions 113 provided therein.

Unlike the prior art cover plate 2, however, the cover plate 102 of this invention has a first sealing structure 114a that extends from the bottom surface of the actuator cavity 111 and completely about the perimeter of the first recessed area 112a. Similarly, the cover plate 102 of this invention also has a second sealing structure 114b that extends from the bottom surface of the actuator cavity 111 and completely about the perimeter of the second recessed area 112b. In the illustrated embodiment, each of the sealing structures 114a and 114b is a wall that is generally trapezoidal in cross-sectional shape and includes four linearly-extending wall segments that extend adjacent to the four sides of the recessed areas 112a and 112b. However, the sealing structures 114a and 114b may be formed having any desired cross-sectional shape or combination of shapes, and may further extend in any desired manner (linearly or otherwise) about the recessed areas 112a and 112b. For example, the sealing structures 114a and 114b may be formed substantially as shown in FIGS. 9 and 12, but may have rounded corners between adjacent linearly-extending wall segments, have one or more non-linearly-extending wall segments, or be entirely non-linear in shape. The purpose for the sealing structures 114a and 114b will be explained below.

The structure of the intermediate plate 103 of this invention is illustrated in detail in FIG. 10. As shown therein, the intermediate plate 103 of this invention includes a displaceable member, indicated generally at 130, that includes a sealing portion 131 having a pair of openings 131a and 131b formed therethrough. The sealing portion 131 is connected through an elongated arm portion 132 to a hinge portion 133 that is formed integrally with the intermediate plate 103 of this invention. The displaceable member 130 also includes a plurality of actuator ribs 134 that is connected through a central spine 135 to the elongated arm portion 132 at a location that is intermediate of the sealing portion 131 and the hinge portion 133.

As shown in FIG. 10, first ends of a first portion of the plurality of actuator ribs 134 (the upper ribs 134 when viewing FIG. 10) are flexibly joined at first ends thereof to a first non-moving part of the intermediate plate 103 of this invention. Second ends of the first portion of the plurality of actuator ribs 134 are connected to the central spine 135. The first non-moving part of the intermediate plate 103 of this invention is electrically connected to a first bond pad (not shown) provided on the intermediate plate 103. Similarly, first ends of a second portion of the plurality of actuator ribs 134 (the lower ribs 134 when viewing FIG. 10) are flexibly joined at first ends thereof to a second non-moving part of the intermediate plate 103 of this invention. Second ends of the second portion of the plurality of actuator ribs 134 are also connected to the central spine 135. The second non-moving part of the intermediate plate 103 of this invention is electrically connected to a second bond pad (not shown) provided on the intermediate plate 103. The second bond pad is electrically isolated from the first bond pad, other than through the plurality of actuator ribs 134.

In a manner that is well known in the art, electrical current may be passed from the first bond pad through the plurality of actuator ribs 134 to the second bond pad. Such electrical current causes thermal expansion of the plurality of actuator ribs 134, which causes axial movement of the central spine 135. As described above, the central spine 135 is connected to the elongated arm portion 132. Consequently, axial movement of the central spine 135 causes the elongated arm portion 132 (and, therefore, the sealing portion 131) of the displaceable member 130 to pivot about the hinge portion 133 or otherwise move relative to the rest of the intermediate plate 103 (such movement occurring within a plane defined by the rest of the intermediate plate 103). Thus, the illustrated displaceable member 130 functions as a conventional micro-electro-mechanical system thermal actuator.

The structure of the inner surface 109 of the base plate 104 of this invention is illustrated in detail in FIGS. 11 and 13. As shown therein, the base plate 104 of this invention includes an actuator cavity, indicated generally at 140, that is provided on the inner surface 109 thereof. The illustrated actuator cavity 140 includes an upper actuator arm cavity portion 140a, a central actuator arm cavity portion 140b, a lower actuator arm cavity portion 140c, an actuator rib cavity portion 140d, an actuator spine cavity portion 140e, and a hinge cavity portion 140f. The illustrated actuator cavity 140 also has one or more pressure equalization depressions 141 provided therein.

Unlike the prior art base plate 4, however, the base plate 104 of this invention has a first sealing structure 142a that extends from the bottom surface of the actuator cavity 140 and completely about the perimeter of the first opening 104a. Similarly, the base plate 104 of this invention also has a second sealing structure 142b that extends from the bottom surface of the actuator cavity 140 and completely about the perimeter of the second opening 104b. In the illustrated embodiment, each of the sealing structures 142a and 142b is a wall that is generally trapezoidal in cross-sectional shape and includes four linearly-extending wall segments that extend adjacent to the openings 104a and 104b. However, the sealing structures 142a and 142b may be formed having any desired cross-sectional shape or combination of shapes, and may further extend in any desired manner (linearly or otherwise) about the openings 104a and 104b. For example, the sealing structures 142a and 142b may have rounded corners between adjacent linearly-extending wall segments, have one or more non-linearly-extending wall segments, or be entirely non-linear in shape. The purpose for the sealing structures 142a and 142b will be explained below.

FIG. 14 illustrates the structure of the assembled microvalve 100 of this invention shown in FIGS. 9 through 13. As shown therein, non-recessed portions of the inner surface 106 of the cover plate 102 engage corresponding non-recessed portions of the first surface 107 of the intermediate plate 103. Similarly, non-recessed portions of the inner surface 109 of the base plate 104 engage corresponding non-recessed portions of the second surface 108 of the intermediate plate 103. The upper actuator arm cavity portion 111a provided on the cover plate 102, the intermediate plate 103, and the upper actuator arm cavity portion 140a provided on the base plate 104 all cooperate to define a closed internal cavity in which the sealing portion 131 of the displaceable member 130 is disposed for relative pivoting movement (movement to the left and to the right when viewing FIG. 14).

A first thickness D3 for the closed internal cavity is defined between a bottom surface of the upper actuator arm cavity portion 111a provided on the cover plate 102 and a bottom surface of the upper actuator arm cavity portion 140a provided on the base plate 104 (including the sealing portion 131 of the displaceable member 130 disposed therebetween). That first thickness D3 is significantly larger than a second thickness D4 that is defined by the opposed surfaces of the sealing portion 131 of the displaceable member 130. A third thickness D5 for the closed internal cavity is defined between extended surfaces of the sealing structures 114a and 114b provided on the cover plate 102 and extended surfaces of the sealing structures 142a and 142b provided on the base plate 104. Unlike the first thickness D3, that third thickness D5 is only slightly larger than the second thickness D4 that is defined by the opposed surfaces of the sealing portion 131 of the displaceable member 130.

As a result, a first relatively large space S3 is defined between the upper actuator arm cavity portion 111a provided on the cover plate 102 and the adjacent surface (the upper surface when viewing FIG. 14) of the displaceable member 130. As shown in FIG. 14, this first relatively large space S3 extends mostly, but not completely, throughout the upper actuator arm cavity portion 111a provided on the cover plate 102 and the adjacent (upper) surface of the sealing portion 131 of the displaceable member 130. The thickness of this first relatively large space S3 may be any desired value that is not likely to result in one or more particles (not shown) contained in the fluid leaking through such relatively large space S3 becoming jammed therebetween. For example, the thickness of this first relatively large space S3 may be approximately 50 μm.

Similarly, a second relatively large space S4 is defined between the upper actuator arm cavity portion 140a provided on the base plate 104 and the adjacent surface (the lower surface when viewing FIG. 14) of the displaceable member 130. As shown in FIG. 14, this second relatively large space S4 also extends mostly, but not completely, throughout the upper actuator arm cavity portion 140a provided on the base plate 104 and the adjacent (lower) surface of the sealing portion 131 of the displaceable member 130. The thickness of this second relatively large space S4 may be any desired value that is not likely to result in one or more particles (not shown) contained in the fluid leaking through such relatively large space S4 becoming jammed therebetween. For example, the thickness of this second relatively large space S4 may also be approximately 50 μm.

As mentioned above, the first and second sealing structures 114a and 114b extend from the bottom surface of the actuator cavity 111 and completely about the perimeter of the first and second recessed areas 112a and 112b, respectively. As a result, a first relatively small space S5 is defined between the first and second sealing structures 114a and 114b and the adjacent surface (the upper surface when viewing FIG. 14) of the displaceable member 130. This first relatively small space S5 extends completely throughout the perimeters of the first and second recessed areas 112a and 112b. The thickness of this first relatively small space S5 may be any desired value that is not likely to result in excessive leakage, as described above. For example, the thickness of this first relatively small space S5 may be approximately 3 μm.

Similarly, the first and second sealing structures 142a and 142b extend from the bottom surface of the actuator cavity 140 and completely about the perimeter of the first and second openings 104a and 104b, respectively. As a result, a second relatively small space S6 is defined between the first and second sealing structures 142a and 142b and the adjacent surface (the upper surface when viewing FIG. 14) of the displaceable member 130. This second relatively small space S6 extends completely throughout the perimeters of the first and second openings 104a and 104b. The thickness of this second relatively small space S6 may be any desired value that is not likely to result in excessive leakage, as described above. For example, the thickness of this second relatively small space S6 may be approximately 3 μm.

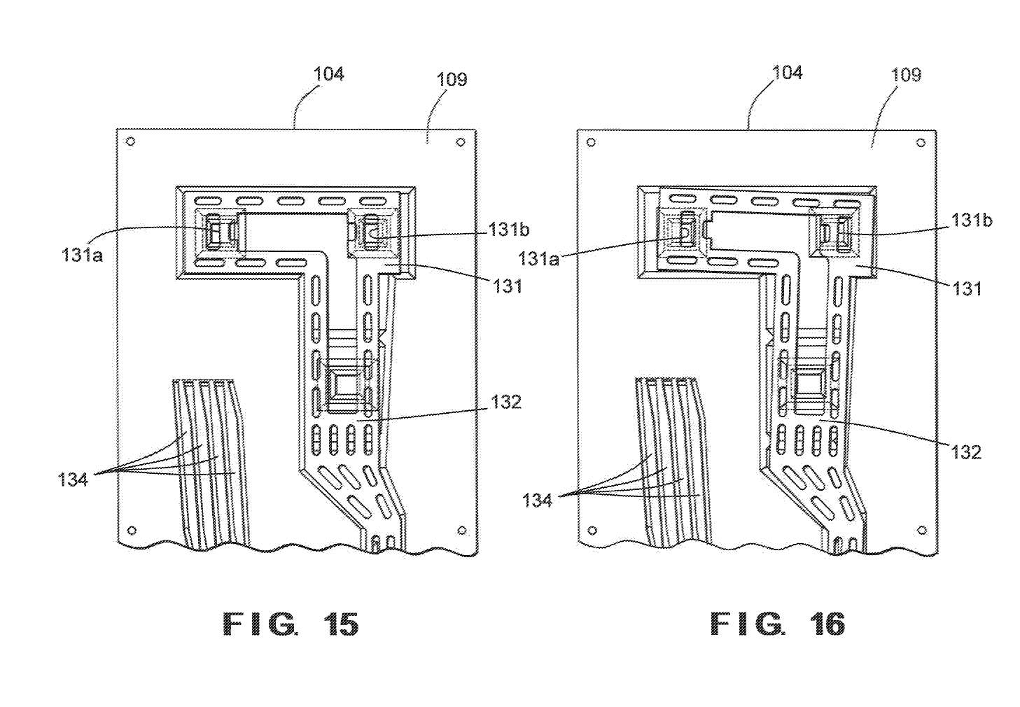

During use, the microvalve 100 can be operated in the conventional manner described above (or otherwise) to selectively move the displaceable member 130 between the closed position (illustrated in FIG. 15) and the opened position (illustrated in FIG. 16). When the displaceable member 130 is located in the closed position, it is desirable that as little fluid as possible flows between the first and second openings 104a and 104b. This is accomplished by providing both (1) the first and second sealing structures 114a and 114b that extend from the bottom surface of the actuator cavity 111 and completely about the perimeter of the first and second recessed areas 112a and 112b, respectively, and (2) the first and second sealing structures 142a and 142b that extend from the bottom surface of the actuator cavity 140 and completely about the perimeter of the first and second openings 104a and 104b, respectively. As discussed above, the relatively small thicknesses of the first and second relatively small spaces S5 and S6 is selected so as to not allow excessive leakage.

At the same time, however, the geometry of the microvalve 100 resists interference with the free movement of a displaceable member of the microvalve that might otherwise result from the presence of particulate contaminants contained in the fluid flowing therethrough. This is accomplished by provided both (1) the first relatively large space S3 between the upper actuator arm cavity portion 111a provided on the cover plate 102 and the adjacent surface (the upper surface when viewing FIG. 14) of the displaceable member 130, and (2) the second relatively large space S4 between the upper actuator arm cavity portion 140a provided on the base plate 104 and the adjacent surface (the lower surface when viewing FIG. 14) of the displaceable member 130. The relatively large thicknesses of the first and second relatively large spaces S3 and S4 is selected so as to prevent one or more particles (not shown) contained in the fluid leaking through the microvalve 100 from becoming jammed therebetween (or at least to minimize the number of such particles that may become jammed therebetween).

As discussed above, in the conventional microvalve 1 illustrated in FIGS. 3 through 8, the relatively small spaces S1 and S2 extend throughout the entire surface areas of the upper and lower surfaces of the displaceable member 30 and the adjacent surfaces of the cover plate 2 and the base plate 4. In the improved microvalve 100 illustrated in FIGS. 9 through 14, however, the relatively small spaces S5 and S6 do not extend throughout the entire surface areas of the upper and lower surfaces of the displaceable member 130 and the adjacent surfaces of the cover plate 102 and the base plate 104. Rather, such relatively small spaces S5 and S6 are present for only small portions of the surface areas of the upper and lower surfaces of the displaceable member 130 and the adjacent surfaces of the cover plate 102 and the base plate 104. As a result, the opportunity for one or more particles (not shown) contained in the fluid leaking through the microvalve 100 from becoming jammed therebetween is significantly minimized.

Although the specific sizes and shapes of the sealing structures 114a, 114b, 142a, and 142b may vary in accordance with the specific operating parameters for a given application, the sealing surfaces areas defined by such sealing structures 114a, 114b, 142a, and 142b for the microvalve 100 are significantly less than the sealing surfaces areas defined between (1) the upper actuator arm cavity portion 11a provided on the cover plate 2 and the adjacent surface (the upper surface when viewing FIG. 8) of the displaceable member 30, and (2) between the upper actuator arm cavity portion 40a provided on the base plate 4 and the adjacent surface (the lower surface when viewing FIG. 8) of the displaceable member 30, up to or in excess of 90% less.

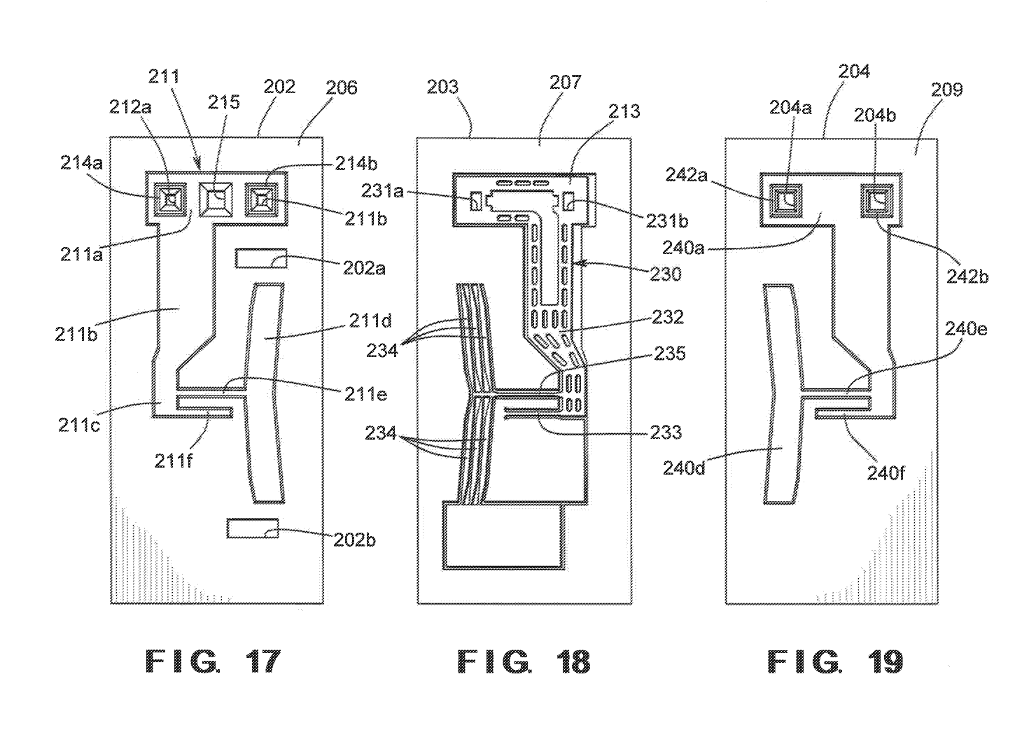

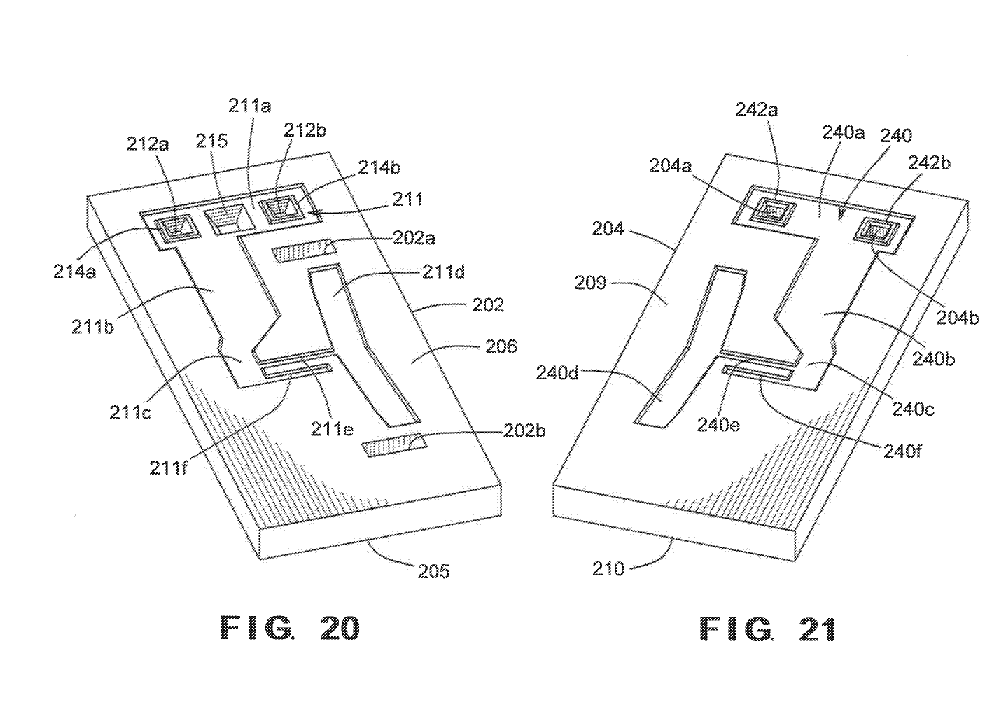

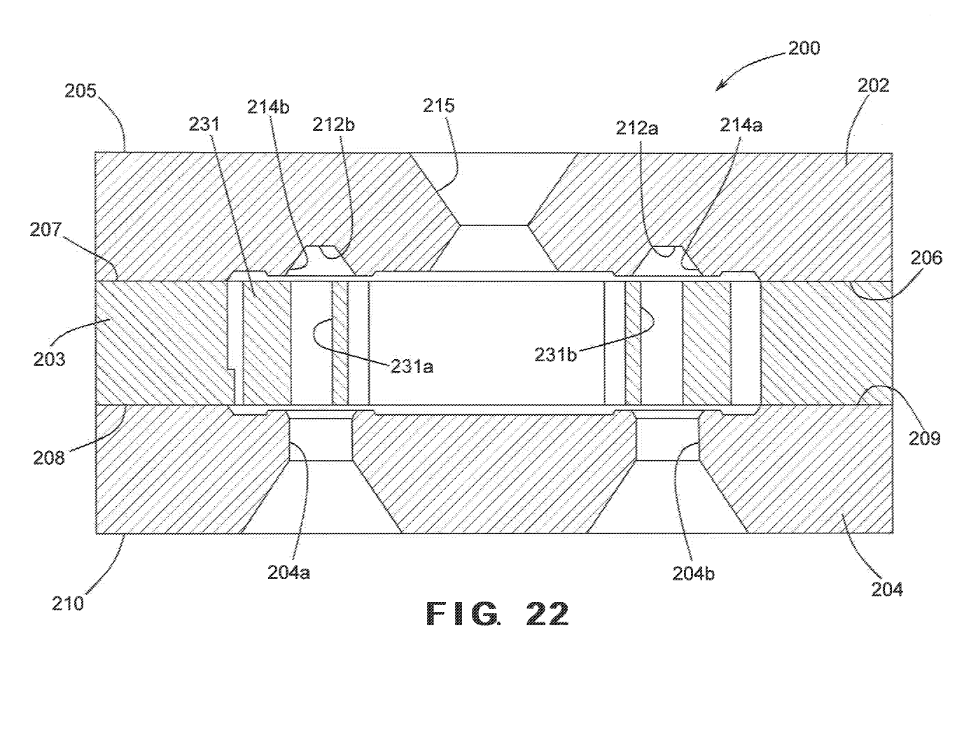

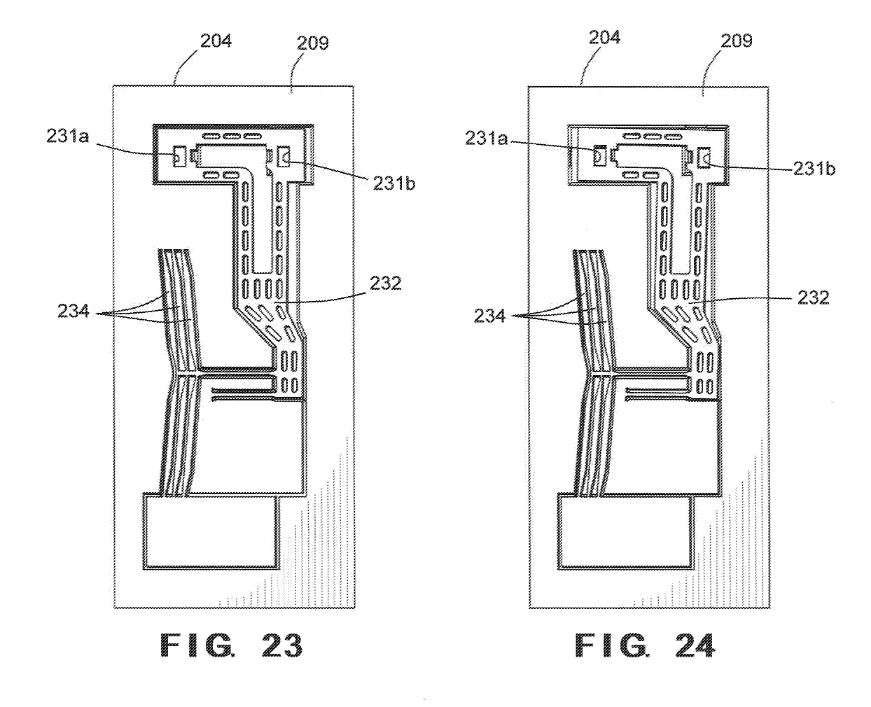

The first embodiment of the microvalve 100 of this invention illustrated in FIGS. 9 through 16 is packaged in a conventional U-flow configuration, wherein the first and second openings 104a and 104b (which define the inlet and outlet to the flow of fluid through the microvalve 100) are located on the same side (the base plate 104 side) of the microvalve 100. A second embodiment of the microvalve, indicated generally at 200, of this invention is illustrated in FIGS. 17 through 24. The second embodiment of the microvalve 200 is similar in many respects to the first embodiment of the microvalve 100, and like reference numbers (incremented by 100) are used to identify similar structures. However, the second embodiment of the microvalve 200 is packaged in a conventional through flow configuration, wherein openings 204a, 204b, and 215 (which define the inlets and outlet to the flow of fluid through the microvalve 200) are located on opposite sides (on the cover plate 202 and the base plate 204 sides) of the microvalve 200. The structure and manner of operation of the second embodiment of the microvalve 200 is otherwise similar to the first embodiment of the microvalve 100.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A microvalve comprising:
a first plate including a surface, a recessed area provided within the surface, a fluid port provided within the recessed area, and a sealing structure extending about the fluid port; and
a second plate having a surface that abuts the surface of the first plate and includes a displaceable member that is movable between a closed position, wherein the displaceable member cooperates with the sealing structure to prevent fluid communication through the fluid port, and an opened position, wherein the displaceable member does not cooperate with at least a portion of the sealing structure to prevent fluid communication through the fluid port.

2. The microvalve defined in claim 1 wherein a first space having a first thickness is defined between the displaceable member and the recessed area of the first plate and a second space having a second thickness is defined between the displaceable member and the sealing structure of the first plate, wherein the first thickness is greater than the second thickness.

3. The microvalve defined in claim 1 wherein the second plate defines a plane, and wherein the displaceable member moves parallel to the plane when moved between the closed and opened positions.

4. The microvalve defined in claim 1 wherein the displaceable member includes a plurality of actuator ribs formed integrally with the second plate for moving the displaceable member between the closed and opened positions.

5. The microvalve defined in claim 1 wherein the displaceable member includes a sealing portion connected through an elongated arm portion to a hinge portion on the second plate.

6. The microvalve defined in claim 5 wherein the displaceable member further includes a plurality of actuator ribs formed integrally with the second plate and connected through a central spine to the elongated arm portion for moving the displaceable member between the closed and opened positions.

7. The microvalve defined in claim 1 wherein the fluid port provided within the recessed area of the first plate is a first fluid port and the sealing structure extending about the first fluid port is a first sealing structure, and further including a second fluid port provided within the recessed area of the first plate and a second sealing structure extending about the second fluid port.

8. The microvalve defined in claim 7 wherein the displaceable member is movable between the closed position, wherein the displaceable member cooperates with the first and second sealing structures to prevent fluid communication between the first and second fluid ports, and the opened position, wherein the displaceable member does not cooperate with at least a portion of the first and second sealing structures to prevent fluid communication between the first and second fluid ports.

9. The microvalve defined in claim 7 wherein the second space is also defined between the displaceable member and the second sealing structure of the first plate.

10. The microvalve defined in claim 7 further including a third fluid port provided within the recessed area of the first plate and a third sealing structure extending about the second fluid port, wherein the second space is also defined between the displaceable member and the third sealing structure of the first plate.

11. A microvalve comprising:
a base plate including a surface, a recessed area provided within the surface, a first fluid port provided within the recessed area, and a first sealing structure extending about the first fluid port;
a cover plate including a surface, a recessed area provided within the surface, a second fluid port provided within the recessed area, and a second sealing structure extending about the second fluid port; and
an intermediate plate having a first surface that abuts the surface of the base plate and a second surface that abuts the surface of the cover plate, the intermediate plate including a displaceable member that is movable between a closed position, wherein the displaceable member cooperates with at least one of the first and second sealing structures to prevent fluid communication between the first and second fluid ports, and an opened position, wherein the displaceable member does not cooperate with at least a portion of at least one of the first and second sealing structures to prevent fluid communication between the first and second fluid ports.

12. The microvalve defined in claim 11 wherein a first space having a first thickness is defined between the displaceable member and the recessed area of the base plate and a second space having a second thickness is defined between the displaceable member and the first sealing structure of the base plate, wherein the first thickness is greater than the second thickness.

13. The microvalve defined in claim 12 wherein a third space having the first thickness is defined between the displaceable member and the recessed area of the cover plate and a fourth space having the second thickness is defined between the displaceable member and the second sealing structure of the cover plate.

14. The microvalve defined in claim 11 wherein the intermediate plate defines a plane, and wherein the displaceable member moves parallel to the plane when moved between the closed and opened positions.

15. The microvalve defined in claim 11 wherein the displaceable member includes a plurality of actuator ribs formed integrally with the intermediate plate for moving the displaceable member between the closed and opened positions.

16. The microvalve defined in claim 11 wherein the displaceable member includes a sealing portion connected through an elongated arm portion to a hinge portion on the intermediate plate.

17. The microvalve defined in claim 16 wherein the displaceable member further includes a plurality of actuator ribs formed integrally with the intermediate plate and connected through a central spine to the elongated arm portion for moving the displaceable member between the closed and opened positions.

18. The microvalve defined in claim 17 wherein the displaceable member is movable between the closed position, wherein the displaceable member cooperates with the first and second sealing structures to prevent fluid communication between the first and second fluid ports, and the opened position, wherein the displaceable member does not cooperate with at least a portion of the first and second sealing structures to prevent fluid communication between the first and second fluid ports.
